(19) United States
(12) Patent Application Publication
(10) Pub. No.: US 2009/0133712 A1
(43) Pub. Date: May 28, 2009

(54) METHODS FOR CLEANING GENERATOR COILS

(75) Inventors: Brock M. Lape, Clifton Park, NY (US); Karl R. Anderson, III, Shorewood, IL (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 11/944,770

(22) Filed: Nov. 26, 2007

(51) Int. Cl. B08B 3/12; B08B 3/10

(52) U.S. Cl. 134/1; 134/32

(57) ABSTRACT

A method for cleaning a generator coil, the method including the step of cleaning the generator coil with a vibratory tank cleaning system. The vibratory tank cleaning system may include means for inducing vibrations through a particulate medium. The vibratory tank cleaning system may include a vibratory tank that holds the particulate medium. The means for inducing vibrations through the particulate medium may be an actuator. In addition to the particulate medium, the vibratory tank also may hold water. In other embodiments, the vibratory tank may hold an acidic aqueous solution or a caustic aqueous solution.

### TECHNICAL FIELD

This present application relates generally to methods for refurbishing and cleaning generator coils. More specifically, but not by way of limitation, the present application relates to methods for refurbishing and cleaning generator coils using a process that include a vibratory tank cleaning process.

### BACKGROUND OF THE INVENTION

Electrical generators generally consist of a rotor that spins a series of large electromagnets within a coil of copper, called the stator. The magnetic field between the coil and the rotating magnets creates an electric current, thus converting the mechanical energy of the spinning rotor into electrical energy. Such generators have many industrial applications. For example, hydro generators are used at dam installments to convert the energy of the flowing water into electrical energy.

Periodically, the copper coils within the electrical generators require servicing, which generally includes a replacement or a refurbishing of the coils for reuse. Economic considerations generally favor refurbishing and reusing the coils over replacing the coils. However, refurbishment is a lengthy and costly process.

One of the significant steps in the refurbishment process is the cleaning of the copper coils. The coils must be cleaned of all of the insulation material that was applied to the coil before use as well as any oxidation or other residue that resides on the coils. The insulation material, which may include fish paper, Nomex® or other similar materials, is baked onto the coils and, thus, is difficult to remove. As a result, the removal process often is labor intensive. After the insulation material is removed and the copper coil is clean, the copper coil may be reinsulated and shipped back to the generator for reuse. Thus, there is a need for improved methods for refurbishing and cleaning generator coils such that the process is more time-efficient and less costly.

### BRIEF DESCRIPTION OF THE INVENTION

The present application thus describes a method for cleaning a generator coil, the method including the step of cleaning the generator coil with a vibratory tank cleaning system. The vibratory tank cleaning system may include means for inducing vibrations through a particulate medium. The vibratory tank cleaning system may include a vibratory tank that holds the particulate medium. The means for inducing vibrations through the particulate medium may be an actuator. In addition to the particulate medium, the vibratory tank also may hold water. In other embodiments, the vibratory tank may hold an acidic aqueous solution or a caustic aqueous solution.

The step of cleaning the generator coil with the vibratory tank cleaning system further may include submerging the generator coil in the particulate medium and water in the vibratory tank. In some embodiments, the generator coil may remain submerged in the particulate medium for between about 0.5 and 3.0 hours. In other embodiments, the generator coil may remain submerged in the particulate medium for approximately 1 hour.

In some embodiments, the particulate medium may include a multitude of ceramic particles. The particulate medium may include cubed shaped particles. Each of the sides of the cubed shaped particles may measure approximately 20 mm. The particulate medium also may include pyramidal shaped particles.

The method may further include the step of hand cleaning the generator coil after the step of cleaning the generator coil with the vibratory tank cleaning system. The method also may further include the step of cleaning the generator coil with an ultrasonic cleaning system. The ultrasonic cleaning system may include means for passing ultrasonic pressure waves through an aqueous solution. The step of cleaning the generator coil with the ultrasonic cleaning system may include submerging the generator coil in the aqueous solution. The generator coil may remain submerged in the aqueous solution for approximately 3 to 4 hours. The step of cleaning the generator coil with the vibratory tank cleaning system may include submerging the generator coil in the particulate medium, wherein the generator coil remains submerged in the particulate medium for approximately 1 hour.

The present application further describes a method for cleaning a generator coil that includes the step of cleaning the generator coil with a vibratory tank cleaning system, where the vibratory tank cleaning system includes: 1) a vibratory tank that holds a particulate medium and water; and 2) means for inducing vibrations through a particulate medium. The step of cleaning the generator coil with a vibratory tank cleaning system may include submerging the generator coil in the particulate medium and water held in the vibratory tank while inducing vibrations through the particulate medium and water. In some embodiments, the particulate medium may include a multitude of cubed shaped ceramic particles.

The method may further include the step of cleaning the generator coil with an ultrasonic cleaning system, the ultrasonic cleaning system including means for passing ultrasonic pressure waves through an aqueous solution. The aqueous solution may include a caustic solution. The aqueous solution may include a temperature between 50° and 85° C. The frequency of the ultrasonic pressure waves may be approximately 30 kHz. The method may further include the step of hand cleaning the generator coil after the steps of cleaning the generator coil with the vibratory tank cleaning system and the ultrasonic cleaning system.

These and other features of the present application will become apparent upon review of the following detailed description of the preferred embodiments when taken in con junction with the drawings and the appended claims.

### BRIEF DESCRIPTION OF THE DRAWINGS

FIG. 1 is a perspective view of a copper coil that may be cleaned and refurbished pursuant to embodiments of the present application.

FIG. 2 is a perspective view of an alternative copper coil that may be cleaned and refurbished pursuant to embodiments of the present application.

FIG. 3 is a perspective view of an alternative copper coil that may be cleaned and refurbished pursuant to embodiments of the present application.

FIG. 4 is a flow diagram illustrating a conventional copper coil cleaning and refurbishment process.

FIG. 5 is a flow diagram illustrating a copper coil cleaning and refurbishment process using ultrasonic cleaning in accordance with an exemplary embodiment of the present application.

FIG. 6 is a schematic plan of an ultrasonic cleaning system in accordance with an exemplary embodiment of the present application.

FIG. 7 is a flow diagram illustrating a copper coil cleaning and refurbishment process using ultrasonic cleaning and vibratory tank cleaning process in accordance with an exemplary embodiment of the present application.

FIG. 8 is a flow diagram illustrating a copper coil cleaning and refurbishment process using a vibratory tank cleaning process in accordance with an exemplary embodiment of the present application.

FIG. 9 is a schematic plan of a vibratory tank cleaning system in accordance with an exemplary embodiment of the present application.

FIG. 10 is a perspective view of a particulate medium used within the vibratory tank cleaning system according to an exemplary embodiment of the present application.

### DETAILED DESCRIPTION OF THE INVENTION

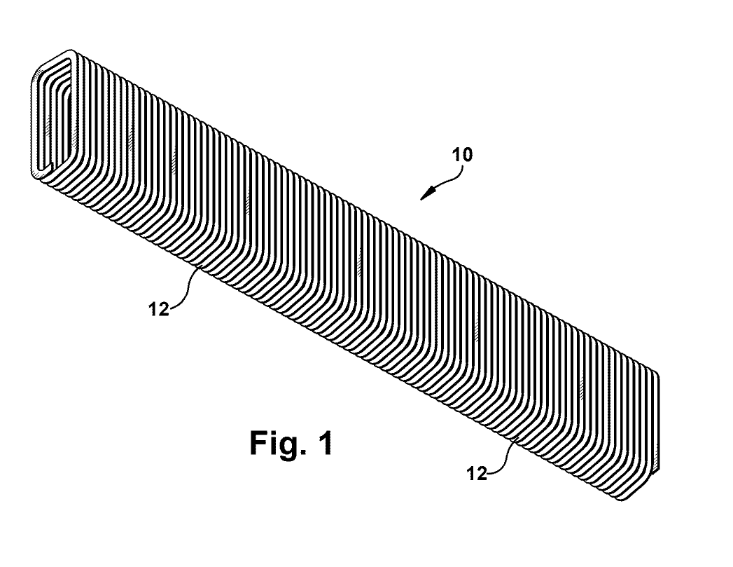

Referring now to the figures, where the various numbers represent like parts throughout the several views, FIGS. 1-3 illustrate various examples of copper coils that are commonly used in generator applications. FIG. 1 illustrates a small copper coil 10. The small copper coil 10 is typical of many of the “small coils” used in smaller generator applications. The small copper coil 10 may be made of copper, though other materials are possible. The small copper coil 10 may include a number of individual coils or turns 12. The small copper coil 10 may be approximately 125 inches long and include approximately 100 turns. The rectangle formed by each of the turns 12 of the small copper coil 10 may be approximately 20 inches long and 10 inches wide. The rectangular cross-section of the copper that makes up the small copper coil 10 may be approximately 0.05″1.25″. The spacing between each of the turns 12 may be approximately 1.25″. The small copper coil 10 may weigh approximately 100 pounds.

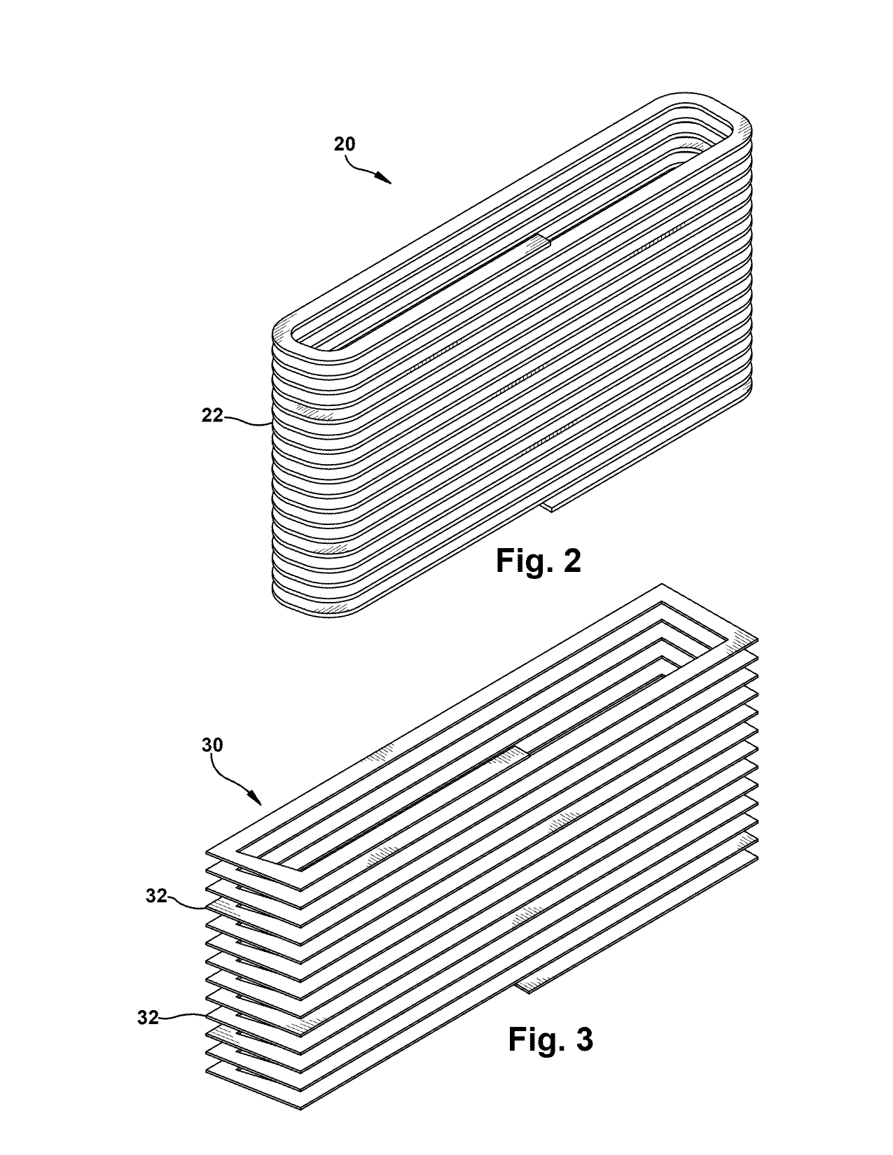

FIG. 2 illustrates a medium copper coil 20. The medium copper coil 20 is typical of many of the “medium coils” used in medium generator applications. The medium copper coil 20 also may be made of copper, though other materials are possible. The medium copper coil 20 may include a number of individual coils or turns 22. The medium copper coil 20 may be approximately 30 inches long and include approximately 17 turns. The rectangle formed by each of the turns 22 of the medium copper coil 20 may be approximately 60 inches long and 10 inches wide. The rectangular cross-section of the copper that makes up the medium copper coil 20 may be approximately 0.5″×1.9″. The spacing between each of the turns 22 may be approximately 1.9″. The medium copper coil 20 may weigh approximately 600 pounds.

FIG. 3 illustrates a large copper coil 30. The large copper coil 30 is typical of many of the “large coils” used in large generator applications. The large copper coil 30 also may be made of copper, though other materials are possible. The large copper coil 30 may include a number of individual coils or turns 32. The large copper coil 30 may be approximately 50 inches long and include approximately 12 turns. The rectangle formed by each of the turns 32 of the large copper coil 30 may be approximately 125 inches long and 25 inches wide. The rectangular cross-section of the copper that makes up the large copper coil 30 may be approximately 0.4″4.3″. The spacing between each of the turns 32 may be approximately 4.3″. The large copper coil 30 may weigh approximately 4000 pounds. As those of ordinary skill in the art will appreciate, copper coils may come in varying and different sizes, both larger and smaller than those described above, depending on the application. The above-described examples are provided to give an overview of the different types of coils that are commonly used. Further, the above-described examples relate to copper coils. Those of ordinary skill in the art will appreciate that the innovative methods described by the present application may be used on coils of different metallic properties. The use of copper throughout the present application is exemplary only.

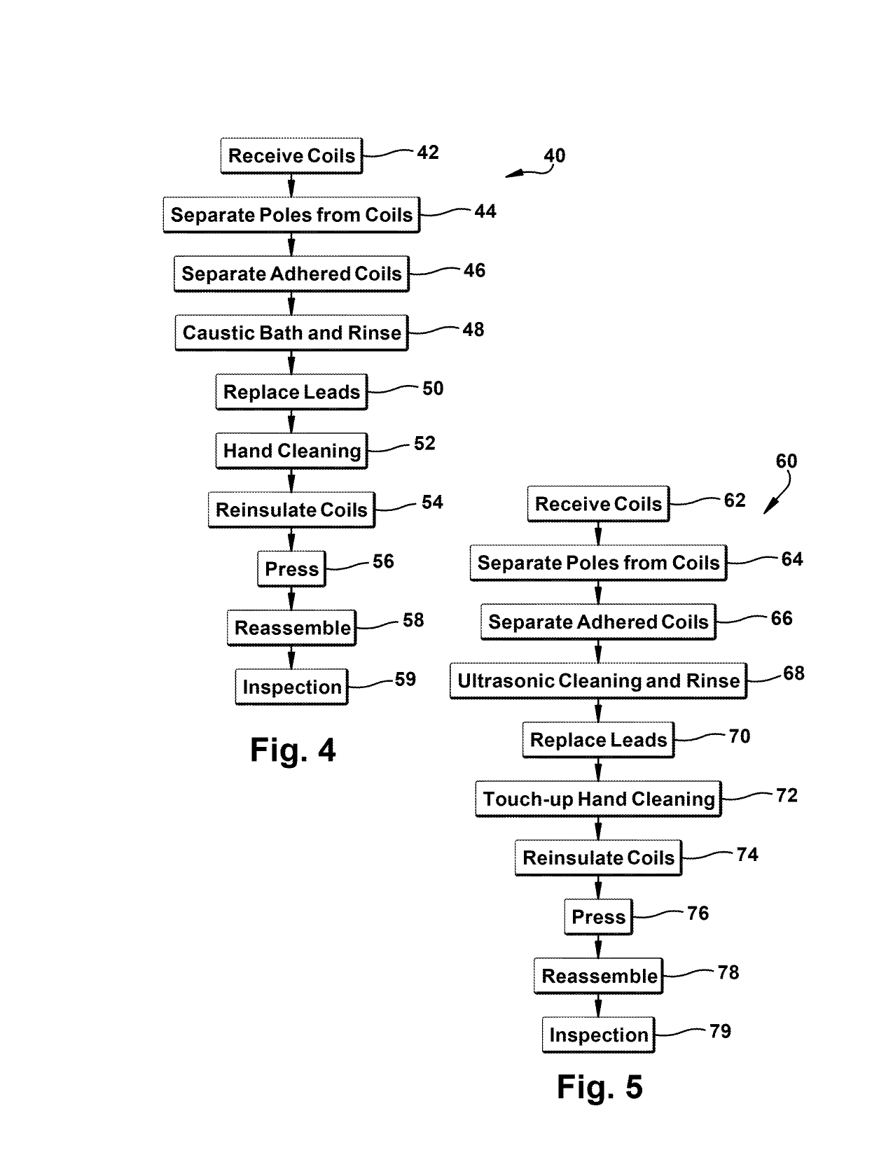

FIG. 4 illustrates a flow diagram 40, which generally demonstrates a conventional cleaning process currently used in the refurbishment of copper coils. The copper coils cleaned and refurbished by this process may include any of the coils discussed above, i.e., the small copper coil 10, the medium copper coil 20 or the large copper coil 30. At a block 42, the copper coil may be received from being shipped from the location of the generator. As described, the received copper coil generally has baked on insulation, oxidation residue and other containments that must be removed before the copper coil can be reinsulated and made ready for reuse. The copper coil, as received, also may have poles attached to them. At a block 44, the poles may be removed from the coil. The removed poles may be cleaned separately by conventional methods (not shown in flow diagram 40). At block 46, any adhered coils may be separated, i.e., any turns within the copper coil that are stuck together may be separated.

With this initial preparation work completed, the coil may be placed in a caustic bath at a block 48. In general, the caustic bath may consist of a submersion within a caustic solution, i.e., a solution with a pH above 7.0. In general, the coil is bathed in the caustic bath for approximately 8-12 hours. The caustic bath takes this amount of time to begin to remove or loosen the insulation and other contaminates from the copper coil. After the caustic bath, the coil may be rinsed with water to remove the caustic solution. Then, at a block 50 the leads of each copper coil may be removed and new leads attached.

The caustic bath at the block 48 generally does not remove all of the insulation from the copper coil. Further, along with the insulation, oxidation residue or other containments may remain on the copper coil after the caustic bath. Thus, at a block 52, it is necessary for the coil to undergo a lengthy hand-cleaning process. Generally, the hand-cleaning consists of a manual cleaning with abrasive pads and a spray-on cleaning agent. The hand-cleaning continues until the copper coil is thoroughly cleaned, i.e., substantially free of insulation, oxidation residue or other contaminants. Generally, on average, each copper coil must undergo 8 hours of hand-cleaning before they are cleaned to a sufficient level.

After the hand-cleaning of the block 52, the copper coil has been sufficiently refurbished such that the process of preparing the copper coils for reuse may begin. Thus, at a block 54, the copper coil may be reinsulated. The reinsulation process generally includes applying new insulation to the copper coil. After reinsulation is complete, the copper coil is pressed at a block 56 and reassembled at a block 58. The reassembly at block 58 includes reattaching the poles that were separated from the copper coil at block 44. After an inspection at a block 59, the refurbished copper coil may be shipped back to the generators for reuse. Or, if the copper coil fails the inspection in some manner, the copper coil may be sent back to the beginning of the process or to any of the intermediate steps as necessary.

The cleaning steps of the refurbishment process, i.e., the caustic bath of block 48 and the hand-cleaning of block 52, generally comprise a significant amount of the overall refurbishment process of block diagram 40. As described above, these two steps may take approximately 16-20 hours per coil, which includes approximately 8-12 hours in the caustic bath and approximately 8 hours of hand-cleaning.

FIG. 5 illustrates a flow diagram 60, which generally demonstrates a copper coil cleaning and refurbishment process using ultrasonic cleaning in accordance with an exemplary embodiment of the present application. The copper coils refurbished by this process may include any of the coils discussed above, i.e., the small copper coil 10, the medium copper coil 20 or the large copper coil 30. At a block 62, the copper coil may be received from being shipped from the location of the generator. As described, the received copper coil generally has baked on insulation, oxidation residue and other containments that must be removed before the copper coil can be reinsulated and made ready for reuse. The copper coil, as received, also may have poles attached to them. At a block 64, the poles may be removed from the copper coil. The removed poles may be cleaned separately by conventional methods (not shown in flow diagram 40). At block 66, any adhered coils may be separated, i.e., any turns within the copper coil that are stuck together may be separated.

With this initial preparation work completed, the coils may be placed in a bath with ultrasonic cleaning at a block 68. In general, the bath with ultrasonic cleaning includes immersion of the coils in an aqueous solution through which ultrasonic pressure waves are passed. Depending on the application, the aqueous solution may be an acidic solution or caustic solution. In the case of an acidic solution, the aqueous solution, in some embodiments, may have a pH of between 1 and 7. In other embodiments, the pH may be approximately 1. The acidic solution may be formed, for example, with citric acid or other similar reactants. As stated, in other embodiments, the aqueous solution may be a caustic solution. In some embodiments, the pH of the caustic solution may be between 8 and 13. In other embodiments, the pH of the caustic solution may be approximately 13. The caustic solution may be formed, for example, with sodium hydroxide or other similar reactants. The temperature of the aqueous solution may be elevated. In some embodiments, the temperature of the aqueous solution may be between 50° and 85° C. In other embodiments, the temperature of the aqueous solution may be approximately 77° C.

The ultrasonic cleaning system and process are described in more detail below. In general, ultrasonic cleaning includes immersing the coils in an aqueous solution through which ultrasonic pressure waves are passed. The ultrasonic pressure waves, as described in more detail below, aid in the removal of insulation, oxidation residue, and other contaminants that are baked on or otherwise attached to the copper coils. In certain embodiments, the frequency of the ultrasonic pressure waves applied through the aqueous solution may be approximately 29 to 31 kHz. Each copper coil may remain immersed in the aqueous solution of the ultrasonic cleaning system for approximately 3-4 hours before the cleaning is complete, though the time may vary depending on the application or the desired level of cleaning. After the immersion in the aqueous solution, the coils may be rinsed with water. The water rinse may include bathing the copper coils in a water tank. In other embodiments, the coils may be sprayed with water. Then, at a block 750 the leads of each copper coil may be removed and new leads attached.

The ultrasonic cleaning at the block 68 generally removes a substantial amount of the insulation and other contaminants from the copper coils. However, some insulation, oxidation residue and/or other contaminants may remain on the copper coils after the ultrasonic cleaning. Thus, at a block 72, a hand cleaning may be performed to remove any of the remaining contaminants. Generally, the hand cleaning includes a brief manual cleaning with abrasive pads and a spray-on cleaning agent. The hand cleaning of block 72 continues until the copper coil is thoroughly cleaned, i.e., substantially free of insulation, oxidation residue or other contaminants. Generally, given the amount of insulation and containments removed during the ultrasonic cleaning of block 68, each copper coil must undergo only approximately 1 hour of hand cleaning before the copper coils are cleaned to a sufficient level.

After the hand cleaning of the block 72, the copper coil have been sufficiently refurbished such that the process of preparing the copper coil for reuse may begin. Thus, at a block 74, the copper coil may be reinsulated. The reinsulation process includes applying new insulation to the copper coil. After reinsulation is complete, the copper coil may be pressed at a block 76 and reassembled at a block 78. The reassembly at block 78 includes reattaching the poles that were separated from the coil at block 64. After an inspection at a block 79, the refurbished copper coil may be shipped back to the generators for reuse. Or, if the copper coil failed the inspection in some manner, the copper coil may be sent back to the beginning of the process or to any of the intermediate steps as necessary.

As illustrated, the cleaning steps of the refurbishment process of flow diagram 40 (i.e., the caustic bath of block 48 and the hand-cleaning of block 52) generally take 16-20 hours per coil, whereas the cleaning steps of the refurbishment process of flow diagram 60 (i.e., the ultrasonic cleaning of block 68 and the hand-cleaning of block 72) generally take 4-5 hours per coil. As such, a significant savings in time is realized.

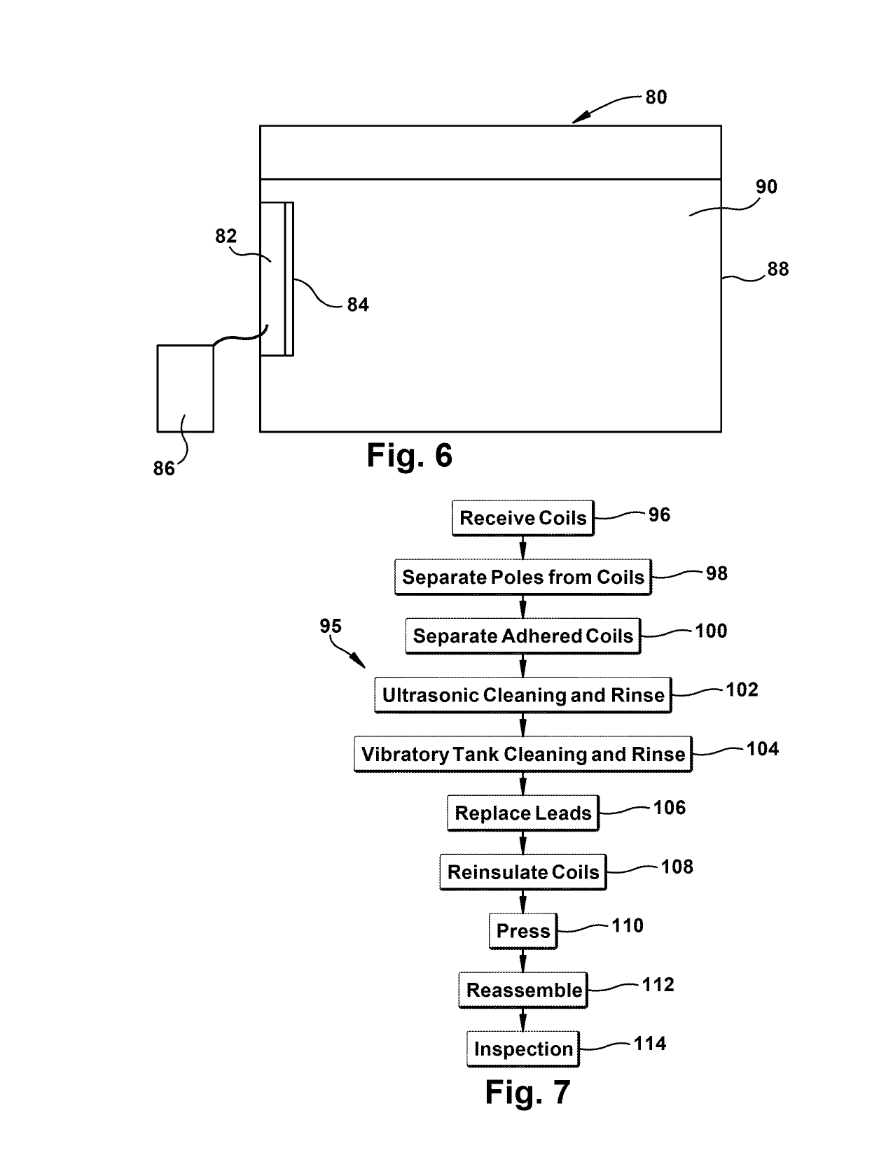

FIG. 6 illustrates a schematic diagram of an exemplary ultrasonic cleaning system 80 that may be used in the process described by the flow diagram 60, though other ultrasonic cleaning systems also may be used. As one of ordinary skill in the art will appreciate, ultrasonic cleaning generally involves the use of high-frequency pressure waves (above the upper range of human hearing, or about 18 kHz) to remove contaminants from parts immersed in an aqueous medium. In a process called cavitation, micron-sized bubbles form and grow due to alternating positive and negative pressure waves in the aqueous medium. The bubbles subjected to these alternating pressure waves continue to grow until they reach resonant size, at which point they implode.

Just prior to the bubble implosion, there is a tremendous amount of energy stored inside the bubble itself. Temperature inside a cavitating bubble can be extremely high, with pressures up to 500 atm. The implosion event, when it occurs near a hard surface, changes the bubble into a jet about one-tenth the bubble size, which travels at speeds up to 400 km/hr toward the hard surface. With the combination of pressure, temperature, and velocity, the jet frees contaminants from their bonds with the substrate. Because of the inherently small size of the jet and the relatively large energy, ultrasonic cleaning has the ability to reach into small crevices and remove entrapped contaminants, which may include the removal of the insulation and other contaminants found on the copper coils, very effectively.

In general, in order to produce the positive and negative pressure waves in the aqueous medium, a mechanical vibrating device, which typically consists of a diaphragm attached to high-frequency transducers, is used. The transducers, which vibrate at their resonant frequency due to a high-frequency electronic generator source, induce amplified vibration of the diaphragm. This amplified vibration is the source of the positive and negative pressure waves that propagate through an aqueous solution in a tank. When transmitted through the aqueous solution, these pressure waves create the cavitation processes. The resonant frequency of the transducer determines the size and magnitude of the resonant bubbles. Typically, ultrasonic transducers used in the cleaning industry range in frequency from 20 to 80 kHz.

FIG. 6 illustrates the basic components of the ultrasonic cleaning system 80, which may include a bank of ultrasonic transducers 82 mounted to a radiating diaphragm 84, an electrical generator 86, and a tank 88 filled with an aqueous solution 90. As one of ordinary skill in the art will appreciate, the ultrasonic cleaning system 80 described herein is exemplary only. Other ultrasonic cleaning systems may be used. The ultrasonic transducers 82 may include piezoelectric transducers, magnetostrictive transducers or the like. In some embodiments, magnetostrictive tranducers may be preferable because of their ruggedness and durability.

The electrical generator 86 may convert a standard electrical frequency of 60 Hz into the high frequencies required in ultrasonic cleaning process, generally in the range of 20 to 80 kHz. As described above, the frequency used in the cleaning of the copper coils may be approximately 30 kHz. In some embodiments, the frequency may sweep between 29.5 and 30.5 kHz to eliminate standing waves and hot spots in the tank 88. The high frequency output of the electrical generator 96 may be used to vibrate the ultrasonic transducers 82 at their resonant frequencies, which may induce amplified vibration of the diaphragm 84. In some embodiments, the electrical generator 86 may include sweep frequency and/or autofollow circuitry.

The tank 88 may be rectangular in nature and be sized such that it allows the complete immersion of a copper coils, which may be, for example, any one of the copper coils discussed above (i.e., the small copper coil 10, the medium copper coil 20 or the large copper coil 30), in the aqueous solution 90. The ultrasonic transducers 82 may be placed, by weld or other means, on the bottom and/or the sides of the tank 88. The tank 88 generally will be sturdy in construction such it may support the copper coils, the aqueous solution 90 and other equipment. Ultrasonic cleaning systems generally may use any of several types of aqueous medium. In the application of cleaning and refurbishing copper coils, the aqueous solution 90 used in the ultrasonic cleaning system 90 may be caustic solution, though, as described above, an acidic solution also may be used.

In one embodiment, the ultrasonic cleaning system 80 may operate as follows. The copper coils and, if present, a cart (not shown) for carrying the copper coils may be immersed into the aqueous solution 90. The aqueous solution 90 may be a solution of sodium hydroxide having a pH of approximately 13. The sodium hydroxide solution, in some embodiments, may be heated to approximately 160° F. The frequency of the pressure waves applied through the sodium hydroxide solution may sweep between 29.5 to 30.5 kHz. Immersion into the solution may last approximately 3 to 4 hours, at which point the ultrasonic cleaning process may be complete and copper coils removed from the tank 88.

In some embodiments, the copper coil cleaning and refurbishment process using ultrasonic cleaning may be augmented with a vibratory tank cleaning process. FIG. 7 illustrates a flow diagram that includes a vibratory tank cleaning process in accordance with an exemplary embodiment, a flow diagram 95. As with the flow diagram 40, 60, the copper coils refurbished by this process may include any of the coils discussed above, i.e., the small copper coil 10, the medium copper coil 20 or the large copper coil 30. At a block 96, the copper coil may be received from being shipped from the location of the generator. At a block 98, the poles may be removed from the copper coil. The removed poles may be cleaned separately by conventional methods (not shown in flow diagram 95). At a block 100, any adhered coils may be separated, i.e., any turns within the copper coil that are stuck together may be separated.

With this initial preparation work completed, the copper coil may be placed in a bath with ultrasonic cleaning at a block 102. In general, as described above in relation to flow diagram 60, the bath with ultrasonic cleaning may include immersion of the copper coil in an aqueous solution through which ultrasonic waves are passed. Each copper coil may remain immersed in the aqueous solution of the ultrasonic cleaning system for approximately 1 to 4 hours before cleaning is complete, though the time may vary depending on the application or the desired level of cleaning. After the immersion in the aqueous solution, the coils may be rinsed with water.

After the ultrasonic cleaning, the copper coil may undergo a vibratory tank cleaning process at a block 104. As described in more detail below, the vibratory tank cleaning process may include placing the copper coil within a mixture of particulate medium through which vibrations are induced. In general, the vibrations cause the particulate medium to rub against the copper coils. It is this rubbing that removes any remaining insulation or other containments not removed by the ultrasonic cleaning process of block 102. Further, the rubbing may remove any metallic burrs that have developed on the copper coils, which beneficially smoothes the copper coil before insulation is reapplied. The copper coil may undergo the vibratory tank cleaning process for approximately 1 hour, at which point the copper coils may be substantially clean of insulation, other containments and metallic spurs. Then, at a block 106 the leads of each copper coil may be removed and new leads attached.

Because of the combination of ultrasonic and vibratory tank cleaning processes, a hand cleaning may not be necessary, as the copper coil may already be substantially free of insulation and other containments. Thus, after the new leads are attached, the coils may be sufficiently refurbished such that the process of preparing the coils for reuse may begin. Thus, at a block 108, the coils may be reinsulated. The reinsulation process includes applying new insulation to the copper coil. After reinsulation is complete, the copper coils are pressed at a block 110 and reassembled at a block 112. The reassembly at block 112 may include reattaching the poles that were separated from the coils at block 98. After an inspection at a block 114, the refurbished copper coil may be shipped back to the generator for reuse. Or, if the copper coil failed the inspection in some manner, the copper coil may be sent back to the beginning of the process or to any of the intermediate steps as necessary.

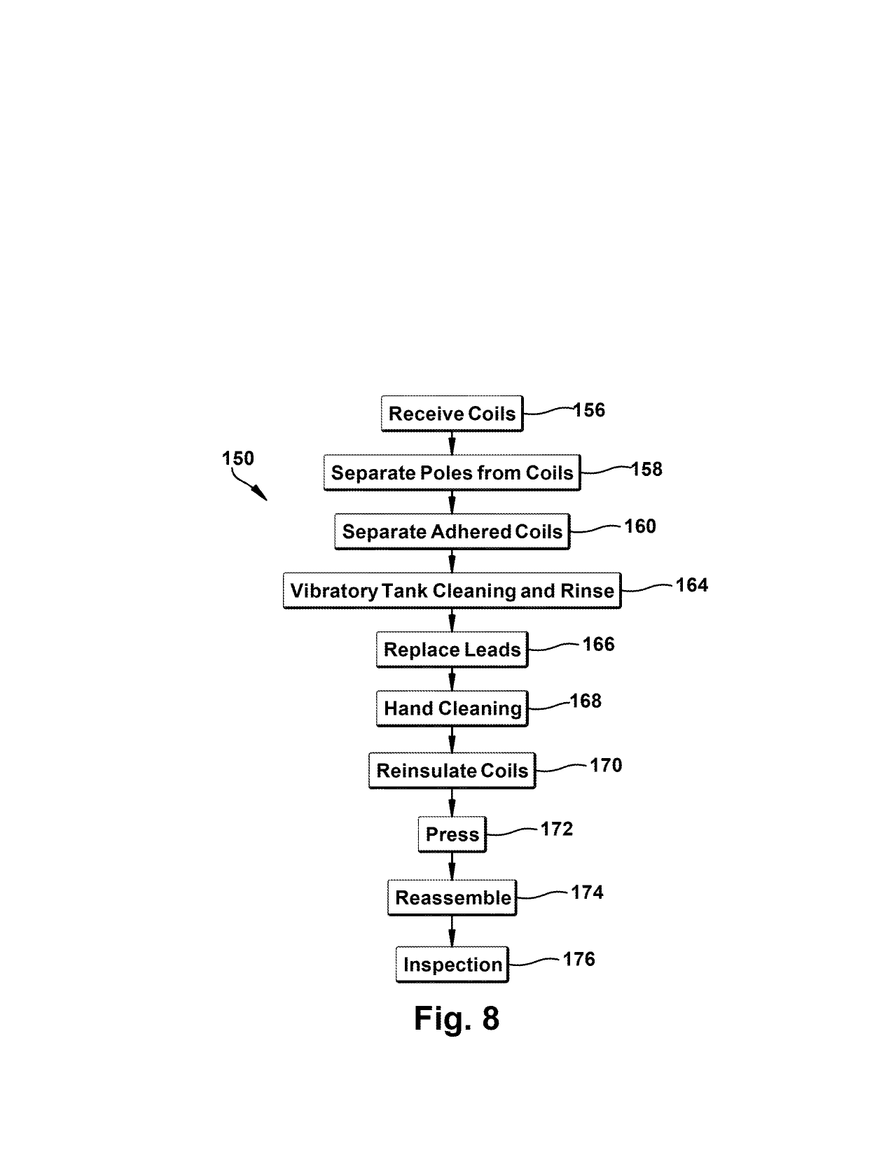

In some embodiments, a copper coil cleaning and refurbishment process may include the vibratory tank cleaning process without the ultrasonic cleaning process described above. FIG. 8 illustrates a flow diagram that includes the vibratory tank cleaning process in accordance with an exemplary embodiment, a flow diagram 150. As with the flow diagram 40, 60, and 95, the copper coils refurbished by this process may include any of the coils discussed above, i.e., the small copper coil 10, the medium copper coil 20 or the large copper coil 30. At a block 156, the copper coil may be received from being shipped from the location of the generator. At a block 158, the poles may be removed from the copper coil. The removed poles may be cleaned separately by conventional methods (not shown in flow diagram 150). At a block 160, any adhered coils may be separated, i.e., any turns within the copper coil that are stuck together may be separated.

With this initial preparation work completed, the copper coil may undergo the vibratory tank cleaning process at a block 164. As described in more detail below, the vibratory tank cleaning process may include placing the copper coil within a mixture of particulate medium through which vibrations are induced. In general, the vibrations cause the particulate medium to rub against the copper coils. It is this rubbing that removes the insulation or other containments from the copper coils. Further, the rubbing may remove any metallic burrs that have developed on the copper coils, which beneficially smoothes the copper coil before insulation is reapplied. The copper coil may undergo the vibratory tank cleaning process for approximately 0.5-3.0 hours. In some embodiments, the copper coil may undergo the vibratory tank cleaning process for approximately 1 hour. The time for the vibratory tank cleaning process may vary depending upon such factors as the type of insulation on the coils and physical condition of the coil. After the vibratory tank cleaning process, the copper coils may be substantially clean of insulation, other containments and metallic spurs. Then, at a block 166 the leads of each copper coil may be removed and new leads attached.

The vibratory tank cleaning process at the block 164 generally removes a substantial amount of the insulation and other contaminants from the copper coils. However, some insulation, oxidation residue and/or other contaminants may remain on the copper coils after the vibratory tank cleaning process. Thus, at a block 168, a hand cleaning may be performed to remove any of the remaining contaminants. Generally, the hand cleaning includes a brief manual cleaning with abrasive pads and a spray-on cleaning agent. The hand cleaning of block 168 continues until the copper coil is thoroughly cleaned, i.e., substantially free of insulation, oxidation residue or other contaminants. Generally, given the amount of insulation and containments removed during the vibratory tank cleaning process, each copper coil must undergo only approximately 1 hour of hand cleaning before the copper coils are cleaned to a sufficient level.

At a block 170, the coils may be reinsulated. The reinsulation process includes applying new insulation to the copper coil. After reinsulation is complete, the copper coils are pressed at a block 172 and reassembled at a block 174. The reassembly at block 174 may include reattaching the poles that were separated from the coils at block 158. After an inspection at a block 176, the refurbished copper coil may be shipped back to the generator for reuse. Or, if the copper coil failed the inspection in some manner, the copper coil may be sent back to the beginning of the process or to any of the intermediate steps as necessary.

FIG. 8 illustrates an exemplary vibratory tank cleaning system 180. As one of ordinary skill in the art would appreciate, the vibratory tank cleaning system 180 may include a vibratory tank 182 and an actuator (not shown) that induces the vibratory tank 122 to vibrate. As pictured, a large copper coil 30 may be loaded on a rack 184 that supports the large copper coil 30 and also separates the individual turns 32. In some embodiments, as shown, the rack 184 may have round end plates 186 at each end. The round end plates 186 may allow the rack 184 and copper coil 30 loaded thereon to rotate within the vibratory tank 182 while the vibratory tank 182 is being vibrated, which may aid in the cleaning process.

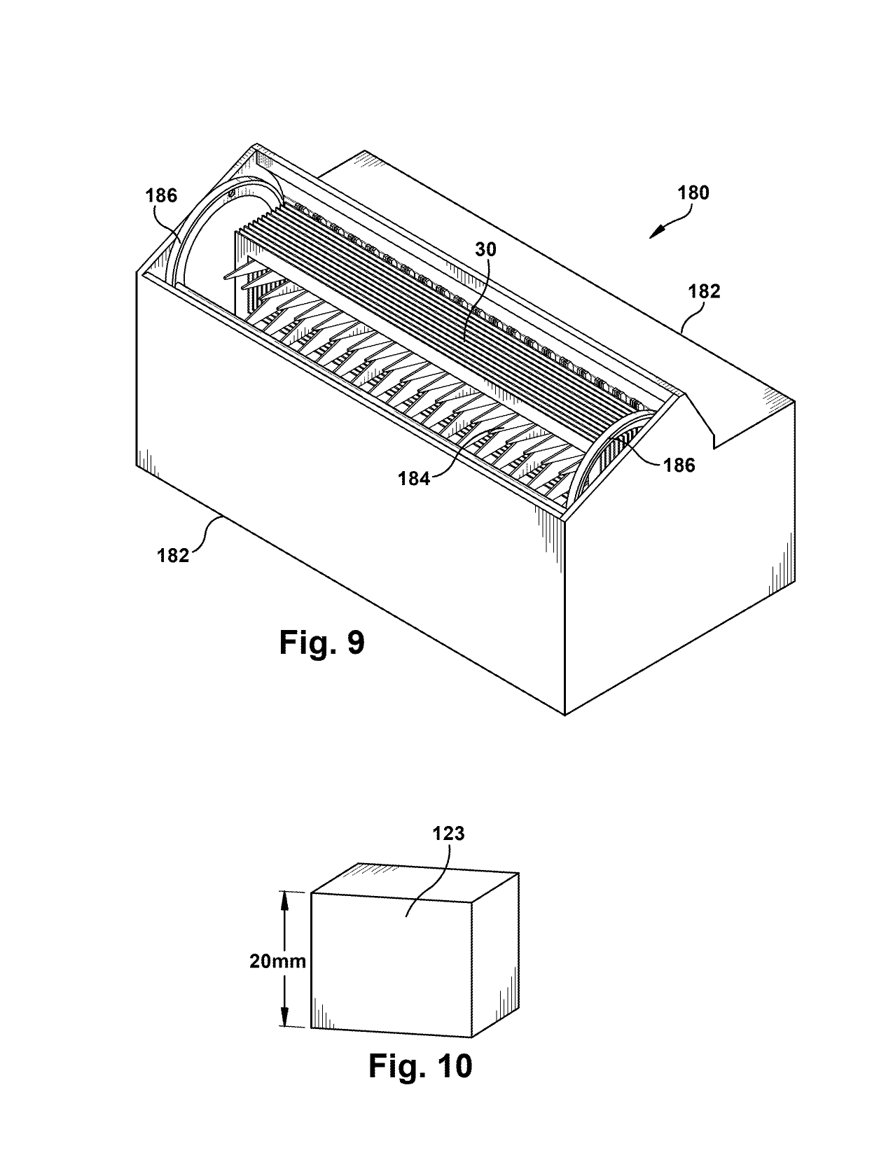

As stated, the vibratory tank 182 may be filled with a mixture of water and a particulate medium (not shown). In some embodiments, the vibratory tank may be filled with acidic solution or caustic aqueous solution and the particulate medium. In some embodiments, the particulate medium may include a multitude of cubed shaped particles 123. As illustrated in FIG. 9, each of the sides of the square shaped faces of the cubed shaped particles may measure approximately 20 mm. As one of ordinary skill in the art will appreciate, particles of other shapes, such as pyramid shaped, may be used. In some embodiments, the particulate medium may be ceramic. Those of ordinary skill in the art will appreciate that other types of vibratory tank cleaning systems may be used.

In use, the copper coil 30 may be submerged in the mixture of water and particulate medium within the vibratory tank 122. The actuator may be activated such that the vibratory tank 122 is vibrated. The vibration may cause the particulate medium to rub against the copper coil 30, which will remove any insulation, other contaminants and/or metal spurs that remain on the copper coil. The actuator may cause the copper coil and rack 126 to rotate within the vibratory tank 122, which may further increase the amount of rubbing that takes place between the copper coil and the particulate medium. The actuator may be deactivated after approximately 1 hour and the copper coil removed from the vibratory tank 122. The time that the copper coil 30 is in the vibratory tank 122 may be increased or decreased depending on the level of cleaning desired.

From the above description of preferred embodiments of the invention, those skilled in the art will perceive improvements, changes and modifications. Such improvements, changes and modifications within the skill of the art are intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

We claim:

1. A method for cleaning a generator coil, the method comprising the step of cleaning the generator coil with a vibratory tank cleaning system, the vibratory tank cleaning system including means for inducing vibrations through a particulate medium.

2. The method of claim 1, wherein:
the vibratory tank cleaning system comprises a vibratory tank that holds the particulate medium; and
the means for inducing vibrations through the particulate medium comprises an actuator.

3. The method of claim 2, wherein, in addition to the particulate medium, the vibratory tank holds water.

4. The method of claim 2, wherein, in addition to the particulate medium, the vibratory tank holds an acidic aqueous solution.

5. The method of claim 2, wherein, in addition to the particulate medium, the vibratory tank holds a caustic aqueous solution.

6. The method of claim 3, wherein the step of cleaning the generator coil with the vibratory tank cleaning system includes submerging the generator coil in the particulate medium and water in the vibratory tank.

7. The method of claim 6, wherein the generator coil remains submerged in the particulate medium for between about 0.5 and 3.0 hours.

8. The method of claim 6, wherein the generator coil remains submerged in the particulate medium for approximately 1 hour.

9. The method of claim 1, wherein the particulate medium includes a multitude of ceramic particles.

10. The method of claim 9, wherein the particulate medium comprises cubed shaped particles.

11. The method of claim 10, wherein each of the sides of the cubed shaped particles measures approximately 20 mm.

12. The method of claim 9, wherein the particulate medium comprises pyramidal shaped particles.

13. The method of claim 1, further comprising the step of hand cleaning the generator coil after the step of cleaning the generator coil with the vibratory tank cleaning system.

14. The method of claim 1, further comprising the step of cleaning the generator coil with an ultrasonic cleaning system, the ultrasonic cleaning system including means for passing ultrasonic pressure waves through an aqueous solution.

15. The method of claim 14, wherein the step of cleaning the generator coil with the ultrasonic cleaning system includes submerging the generator coil in the aqueous solution;
wherein the generator coil remains submerged in the aqueous solution for approximately 3 to 4 hours;
wherein the step of cleaning the generator coil with the vibratory tank cleaning system includes submerging the generator coil in the particulate medium; and
wherein the generator coil remains submerged in the particulate medium for approximately 1 hour.

16. A method for cleaning a generator coil, the method comprising the step of cleaning the generator coil with a vibratory tank cleaning system, the vibratory tank cleaning system including:
a vibratory tank that holds a particulate medium and water; and
means for inducing vibrations through a particulate medium;
wherein the step of cleaning the generator coil with a vibratory tank cleaning system includes submerging the generator coil in the particulate medium and water held in the vibratory tank while inducing vibrations through the particulate medium and water.

17. The method of claim 16, wherein the particulate medium includes a multitude of cubed shaped ceramic particles.

18. The method of claim 16, further comprising the step of cleaning the generator coil with an ultrasonic cleaning system, the ultrasonic cleaning system including means for passing ultrasonic pressure waves through an aqueous solution.

19. The method of claim 18, wherein:
the aqueous solution comprises a caustic solution;
the aqueous solution comprises a temperature between 50° and 85° C.; and
the frequency of the ultrasonic pressure waves is approximately 30 kHz.

20. The method of claim 18, further comprising the step of hand cleaning the generator coil after the steps of cleaning the generator coil with the vibratory tank cleaning system and the ultrasonic cleaning system.
